(19) United States
(12) Patent Application Publication
(10) Pub. No.: US 2016/0162158 A1
(43) Pub. Date: Jun. 9, 2016

(54) PREFERENTIAL CHOICE SYSTEM, SOFTWARE, AND METHOD

(71) Applicants: Barbara Edell, El Cajon, CA (US); Matthew J. Dawson, San Diego, CA (US); Steven Janoff, San Diego, CA (US); Craig Lauer, San Diego, CA (US); Ronnie Edell, El Cajon, CA (US)

(72) Inventors: Barbara Edell, El Cajon, CA (US); Matthew J. Dawson, San Diego, CA (US); Steven Janoff, San Diego, CA (US); Craig Lauer, San Diego, CA (US); Ronnie Edell, El Cajon, CA (US)

(21) Appl. No.: 14/157,541

(22) Filed: Jan. 17, 2014

(51) Int. Cl. G06F 3/0484; G06F 3/0481

(52) U.S. Cl. CPC G06F 3/04842; G06F 3/04817

(57) ABSTRACT

A preferential choice system, software, and method of use.

### FIELD OF THE INVENTION

The present invention relates generally to the field of preferential selection system, software and method to provide the same. It may be difficult for an individual to make a preferential choice given merely a text-based menu or survey. Many text-based menu or survey choice systems result in inaccurate or erroneous preferential matching. The present invention allows a choice maker to avoid these inaccuracies or erroneous results by using image-based, rather than text-based, choice systems.

### BACKGROUND OF THE INVENTION

Preferential choice systems have been used for many years in a variety of fields. These include, but are not limited to, candidate or membership review, employee selection or assignment, media preferences, and even match-making This has become more prevalent in the current Internet age, where services and providers utilize the power of both desktop and web-based computational power in trying to help consumers make their choices and to predict these same choices.

Many preferential choice systems are flawed due to either skewed or misleading input and/or inaccurate or imperfect algorithms. Taking match-making sites as an example, consumers may subconsciously, or even intentionally, input data and criteria that do not accurately reflect their personal characteristics or choices. Rather these consumers enter misleading data that is designed to elicit a particular response or mislead other respondents enticing them to make false or assumptive choices based on that data.

Even if the initial input data is accurate and truthful, inaccurate choices and/or matching may occur if the selection algorithm is not correctly applied or appropriately tuned or biased. For example, an algorithm which is too simplistic may be easily gamed by the user inputting data. Additionally, an algorithm which puts too much weight on one or more factors, may also result in either unusually biased results or results which may be predicted, and thus influenced.

Finally, an algorithm is just that, an algorithm. The mechanical application of mathematics to a human selection process, while it may run true statistically over a large number of samples, may still give incorrect selections or choices on an individual basis.

As a result of the above-stated problems and desires, there is a need for a preferential choice system, which minimizes biased or predictive input, and allows for both algorithmic processing and intuitive evaluation. In addition, it is desirable for the preferential choice system to be modifiable for different choice or selection purposes. Furthermore, it may be desirable to have the preferential choice system be available through computer-assisted means.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

### SUMMARY OF INVENTION

The present invention comprises a preferential choice system, software and method of using the same, which enables a user to input selection criteria and generate results based on those criteria.

In one or more embodiments, the preferential choice system may allow a user to create an account. The preferential choice system may allow a user to create an account user profile. The preferential choice system user profile may be created using a word-image association. The user profile may then be uploaded into a data repository. The user profile may then be compared by means of a selection algorithm or intuitive evaluation. The selection algorithm or intuitive evaluation may then be used to compare input criteria against other users' profiles for desired criteria. User profiles which meet desired criteria may then be made available for viewing and potential further action.

In one or more embodiments, the choice of account type may be differentiated into free or paid accounts, each with different levels of access and options.

In one or more embodiments, the profile words to be associated with images may be emotional, intuitive, or personal characteristic words.

In one or more embodiments, a user may select his or her input criteria using a computer, or computer-like device.

In one or more embodiments, the computer, or computer-like device may include, without limitation, a desktop computer, a laptop, tablet, PDA, smart phone, or other electronic device which allows for a user interface such that selection choices may be made through the user interface.

In one or more embodiments, the computer, or computer-like device may be a stand-alone device, a networked device, whether wired or wireless, or other similarly connected or connectable device.

In one or more embodiments, the software driving the user interface may be hosted on the user's computer, or computer-like device, on a network or central server, or it may be cloud-based.

In one or more embodiments, the data repository may be hosted on a network, central server, or on a distributed Internet-based cloud network.

In one or more embodiments, the user interface profile image selection means may be through a keyboard, a mouse, a stylus, voice-activation, touchscreen or touchpad, hand gesture, intuitive finger motion, other interactive or similar user interface input options.

In one or more embodiments, the preferential choice system may allow a user to upload his or her own images.

In one or more embodiments, the preferential choice system may allow a user to choose his or her own selection criteria.

In one or more embodiments, the preferential choice system may allow a user to create his or her own selection criteria.

In one or more embodiments, results of a user defined filter may be displayed on a computer, or computer-like device, which may include, without limitation, a desktop computer, a laptop, tablet, PDA, smart phone, or other electronic device which allows for a display of selection choices which may be made through the user interface.

One or more embodiments of the present invention comprise a software product, further comprising a non-transitory computer device-readable medium in which program instructions are stored, which instructions, when read by at least a first computer device, cause the computer device to display a user interface, wherein a user may create a user account and profile, the user profile being created by means of selecting at least one or more of a plurality of appropriate images associated with at least one or more of a plurality of provided word prompts; a data repository, wherein one or more of a plurality of user profiles are stored; one or more algorithms, wherein desirable selection criteria within the one or more of a plurality of user profiles are compared; and a means for viewing the one or more of a plurality of user profiles which meet the desired selection criteria.

One or more embodiments of the present invention comprise a method of using the preferential choice system described above and claimed in the claims below.

With respect to the above description then, it is to be realized that the optimum characteristics, criteria and interrelationships for the parts of the invention, to include variations in type, number, specific criteria, form, function and manner of use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Other objectives, features and advantages of the invention will become apparent from the following description and drawings herein.

### BRIEF DESCRIPTION OF THE DRAWINGS

FIG. 1 is a flowchart depicting an embodiment of the User Profile Creation.

FIG. 2 is a flowchart depicting an embodiment of the User Discovery information flow.

FIG. 3 is a flowchart depicting an embodiment of the User Interface information flow and options.

FIG. 4 is an exemplary graphical representation of an embodiment of the user interface.

FIG. 5 is an illustration of an embodiment of the user interface.

FIG. 6 is an exemplary graphical representation of an embodiment of the user interface on a mobile device.

FIG. 7 is an illustration of an embodiment of the user interface on a mobile device.

### DETAILED DESCRIPTION OF THE PREFERRED EMBODIMENT

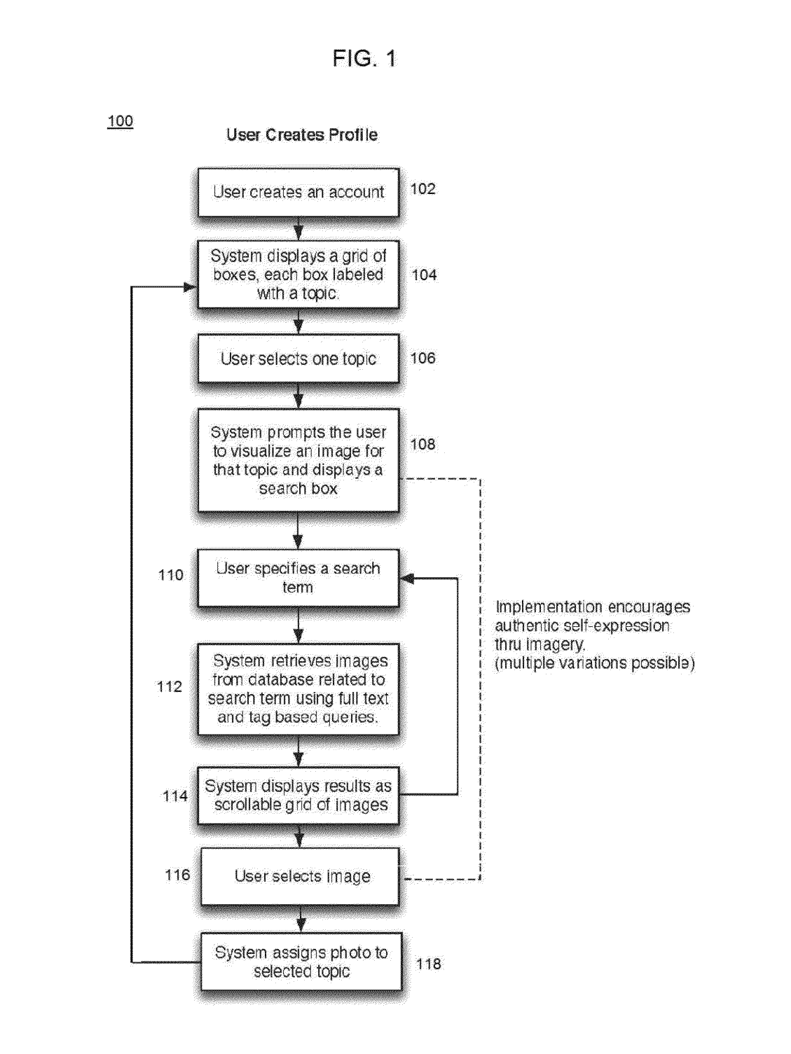

Referring now to FIG. 1, the User Profile Creation 100 may, in one embodiment comprise the following steps. A user creates an account 102, wherein in one embodiment, the system displays a grid of boxes, each box labeled with a topic 104. The user selects their desired topic 106, wherein, in one embodiment, the system displays a search box and prompts the user to select their preferred image 108 for the topic previously selected 106.

The user specifies a search term 110 and, in one embodiment, the system retrieves images from a database 112 related to the search term 110. The system displays the results of the search 112 as a scrollable grid of images 114. The user then selects an image 116. The system then assigns the preferred image to the selected topic 118.

The user may, in one embodiment, iterate steps 104-118 multiple times to populate their profile with their preferred image on a particular topic.

The user may further, in one embodiment, iterate steps 108-118 multiple times to refine their preferred image on a particular topic.

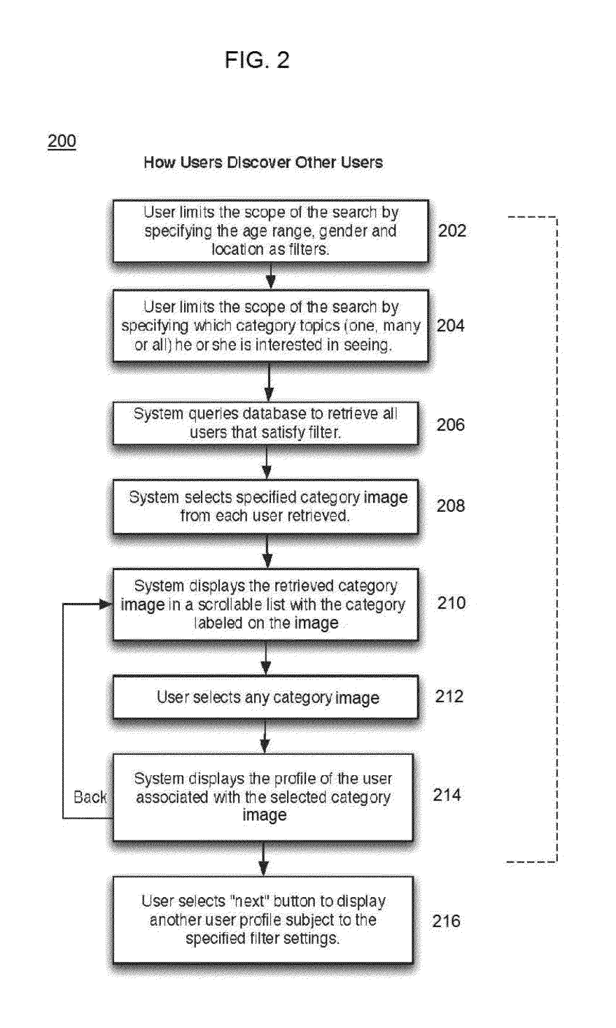

Referring now to FIG. 2, one embodiment of the User Discovery Process 200 provides the steps of the user limiting the scope of their search 202. The scope may be limited by, for example and without limitation, age, gender, and location. The scope may be additionally limited by category topic 204. Category topics may include, for example and without limitation, activities, moods, feelings, emotions, values, states of mind, habits of the heart, colors, types of music, theater, movies, literature, and the like, and specific intuitive or emotional responses or specific exclusions to any or all of the above.

In one embodiment, the system then queries a database to retrieve all profiles that satisfy the user's limitations or filters 206. The system may then, in one embodiment, select the specified category image from each profile retrieved 208.

The system may then display the retrieved category image in a suitable format 210. In one embodiment, the category is labeled on the image. The user may then select any category image 212 and the system displays the profile of the user associated with the selected image 214.

Steps 210 through 214 may be iterated until all selected category images and, if desired, all associated user profiles, have been viewed.

The user may select the next user profile 216 from the results of the system query 206.

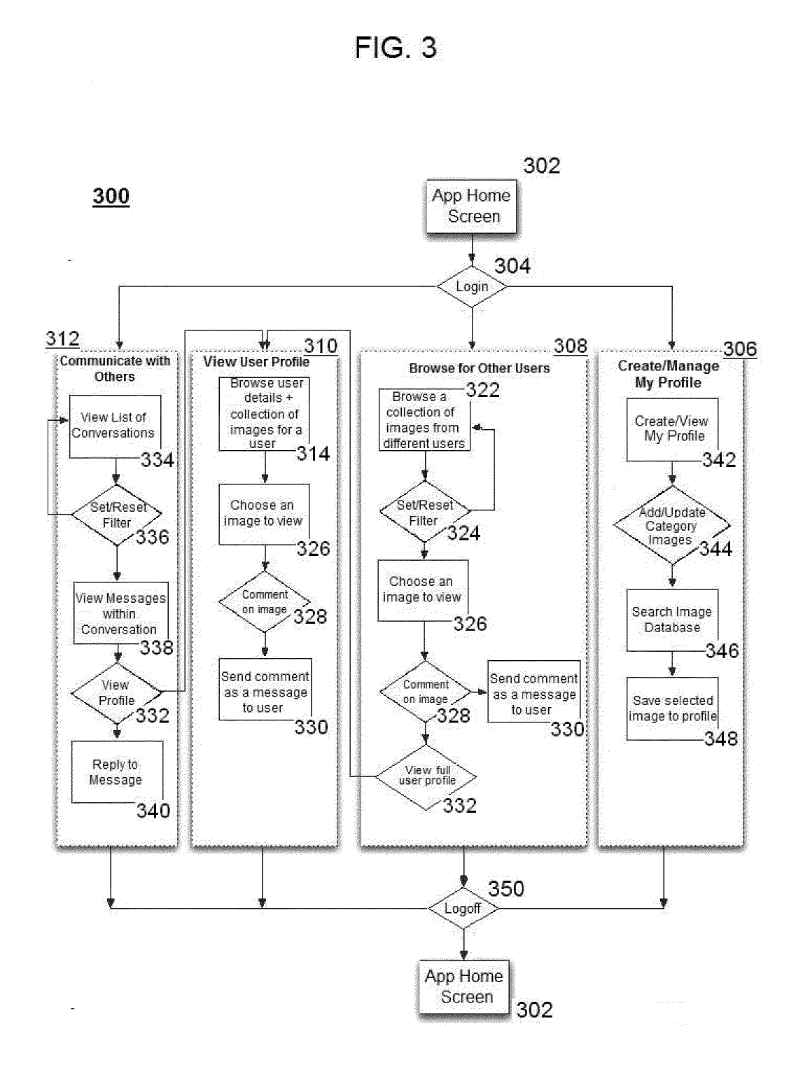

Referring now to FIG. 3, in one embodiment, the user interface system 300, comprises an application home page 302. In one embodiment, the home page 302 further comprises additional options for a user to manipulate and explore. These options may include a login function 304, the creation and management of a new user profile 306, an option to browse other users' profiles 308, the option to view details of a specific profile 310 and an option to communicate with other users 312.

In one embodiment, if the user desires to login 304, the option to create and manage a user profile 306 may become available. The creation and management of the user's profile 306 may include the steps of creating and viewing the profile 342, wherein the user can create a new profile or, if the profile is already created, modify the content. Both creation and modification may, in one embodiment, further comprise the step of adding and updating category images 344. To add or update category images, the user may search the image database 346 and, upon selection of a desired image, may then save the image selected to their profile 348.

Additionally, the user may choose to browse for other users 308. This option may, in one embodiment, be available whether the user has logged in 304 or not. If the user chooses to browse other users, the user may, in one embodiment, browse a collection of images from different users 322. The user may, in one embodiment, set or reset a filter 324, to narrow or broaden their search. The user may then choose an image to view 326 or continue to browse a now filtered collection of images from different users 322. If the user desires to choose an image to view 326, the user may then comment on the image 328. The user may send the comment on the image 328 in the form of a message to the user 330.

The user may also choose to view the full profile of the other selected user 332.

If the user chooses to view the full profile of the other selected user 332 then, in one embodiment, the user may enter the View User Profile module 310. The View User Profile module may, in one embodiment, further comprise the steps of browsing the user details and user image collection 314. The user may then choose an image to view 326 and may then comment on the image 328. The user may then, in one embodiment, send the comment on the image 328 in the form of a message to the user 330.

These messages to other users 330, may also, in one embodiment, be found in the form of conversations. The user may read and respond to these conversations in the Communicate with Others module 312. Within this module, the user may view a list of conversations 334, set or reset a conversation filter 336, and view a particular message within a conversation 338. The user may also, in one embodiment, view the profile of the user 332 who wrote a particular message. From viewing a particular user profile 332, the user may then reply to that user's message 340.

The user may then, when finished with all activities, log off of the system 350 and return to the application home page 302.

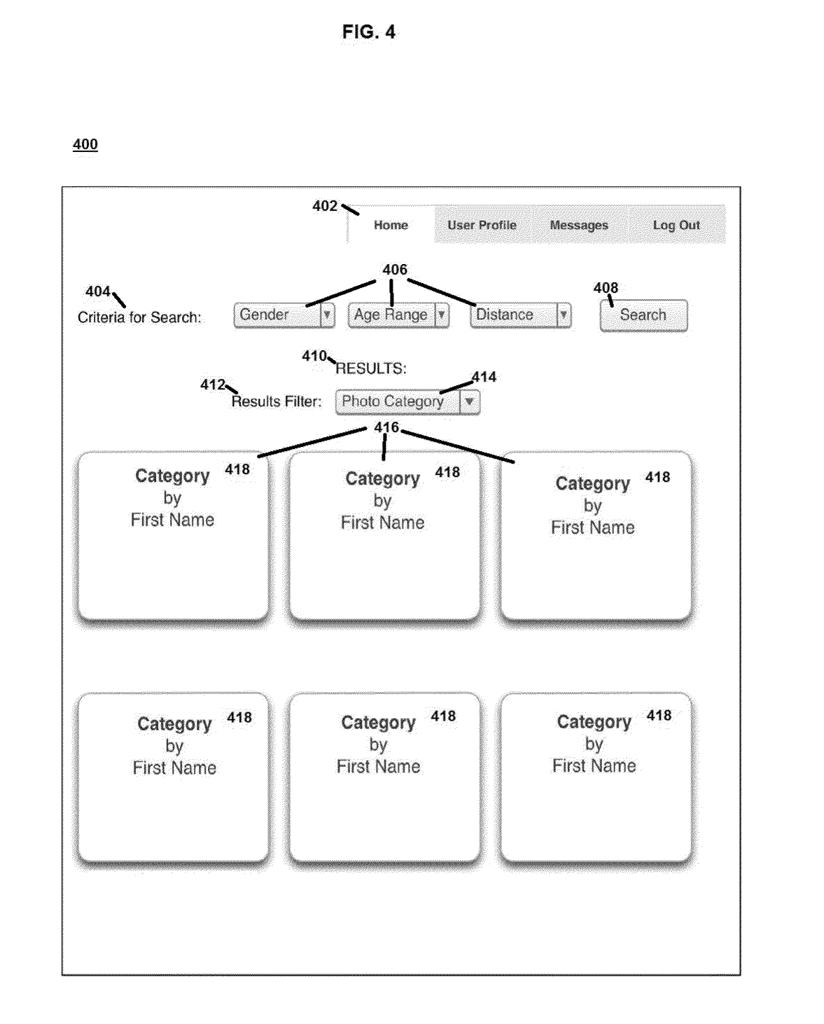

Referring now to FIG. 4, which depicts an embodiment of the user interface 400. User interface 400 may include a series of control tabs 402 to help the user navigate between different functions or different portions of the user interface. In one embodiment, the control tabs include a Home tab, a User Profile tab, a Messages tab and a Log Out tab.

A search criteria function 404 may be provided. In one embodiment, selection criteria tabs 406 include Gender, Age Range and Distance. A Search button 408 is provided to start the search, once the criteria tabs 406 have been selected.

A Results header 410 denotes where the search results will be displayed. The search results may be filtered 412 by selecting a filter criteria 414. The images 416 meeting the search criteria are displayed along with the category name 418.

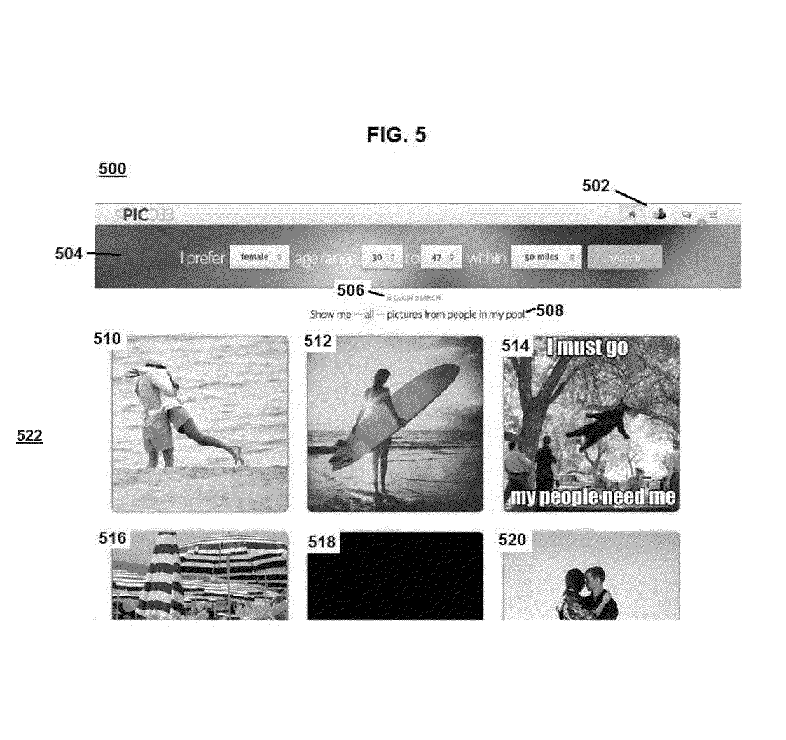

Referring now to FIG. 5, which depicts an illustrative view of one embodiment of the user interface 500. User interface 500 comprises control tabs 502, a search banner 504 and a results display region 522. In this embodiment, control tabs 502 include a Home tab, a User Profile Tab, a Messages tab and a Settings tab. Search banner 504 allows user selection of Gender, Age Range, distance from the user's inputted address, and a Search button to start the search, based on the selected criteria.

In this embodiment, an option to Close Search 506 is located below the search banner 504.

In this embodiment, an option 508 to display a portion, or all, of the results in a sub-group of the entire data set is provided.

The results display region 522 is populated with images 510, 512, 514, 516, 518, 520, which are the results of the user entered search criteria.

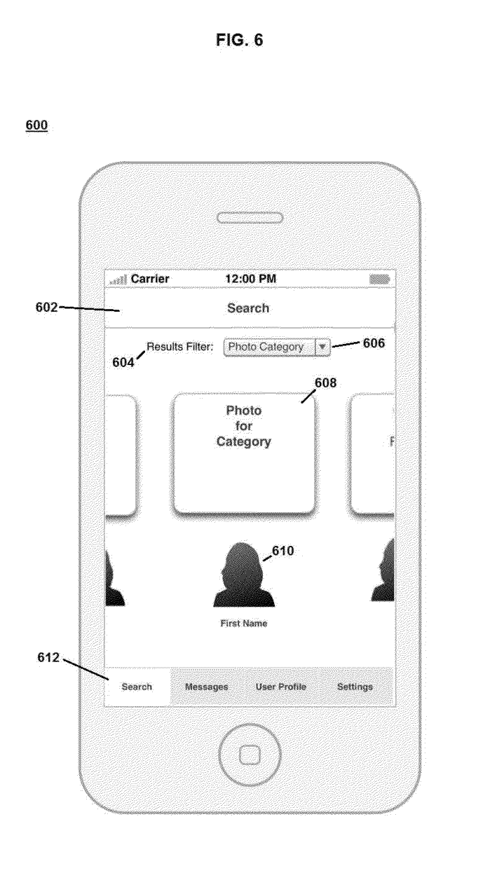

Referring now to FIG. 6, which depicts an embodiment of the mobile user interface. Mobile user interface 600 comprises a function header 602, a search results filter 604, filter criteria 606, an image display area 608, a profile display 610 and a control tab bar 612.

In this embodiment, the control tab bar 612 includes a Search tab, a Messages tab, a User Profile tab, and a Settings tab.

In this embodiment, the Search tab from the control tab bar 612 has been selected. The search results filter 604 has been set with a search criteria 606 of Photo Category. The image 608 and profile 610 associated with the image 608 have been displayed.

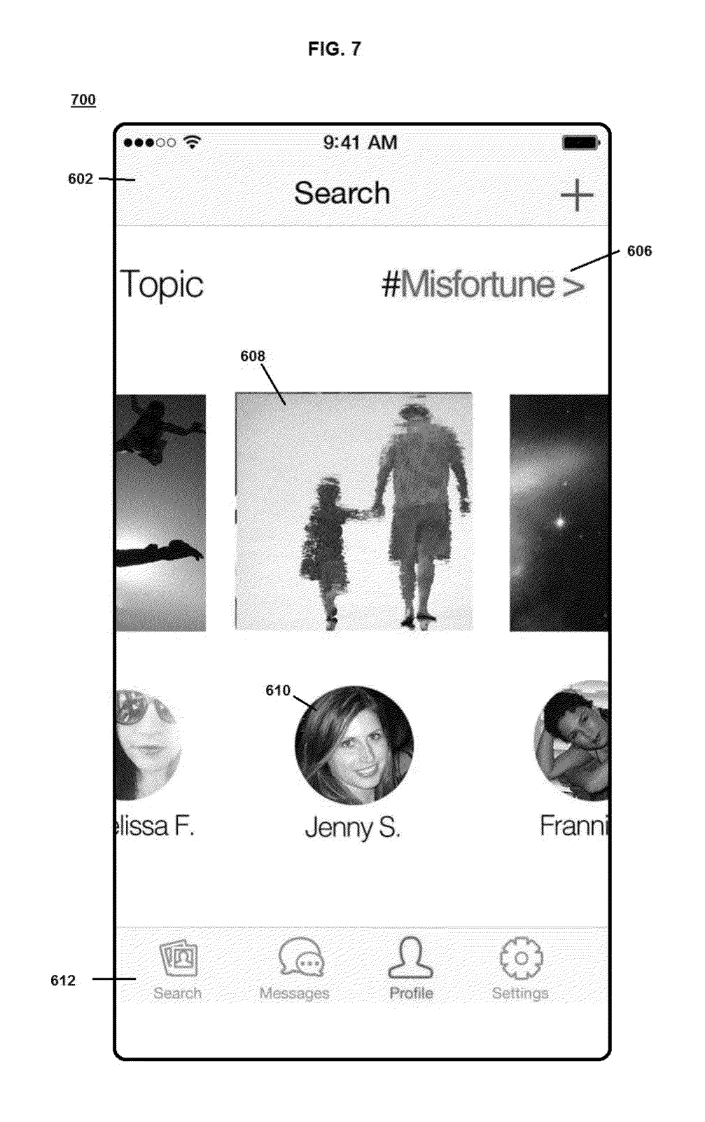

Referring now to FIG. 7, which depicts an illustrative view of one embodiment of the user interface 700. User interface 700 comprises a function header 602, filter criteria 606, an image 608, a profile display 610, and the control tab bar 612. In this embodiment, control tabs 612 include a Search tab, a Messages tab, a Profile Tab, and a Settings tab.

In this illustrative example, Filter Criteria 606 has been set to “Misfortune.” The profile 610 of “Jenny S.” shows a dissolute picture of a man holding a child's hand 608.

We claim:

1. A preferential choice system comprising:
a. a first computer device;
b. a user interface on the first computer device, wherein a user may create a user account and profile;
c. the user profile being created by means of selecting at least one or more of a plurality of appropriate images associated with at least one or more of a plurality of provided word prompts;
d. a data repository, wherein one or more of a plurality of user profiles are stored;
e. a means for selecting desirable criteria within the one or more of a plurality of user profiles; and
f. a means for viewing the one or more of a plurality of user profiles which meet the desired selection criteria.

2. The preferential choice system of claim 1 wherein the means of selecting desirable criteria is a programmed algorithm.

3. The preferential choice system of claim 1 wherein the means of selecting desirable criteria is based on user criteria.

4. A software product, comprising:
a. a non-transitory computer device-readable medium in which program instructions are stored, which instructions, when read by at least a first computer device, cause the computer device to display a user interface, wherein a user may create a user account and profile, the user profile being created by means of selecting at least one or more of a plurality of appropriate images associated with at least one or more of a plurality of provided word prompts;
b. a data repository, wherein one or more of a plurality of user profiles are stored;
c. a means for selecting desirable criteria within the one or more of a plurality of user profiles; and
d. a means for viewing the one or more of a plurality of user profiles which meet the desired selection criteria.

5. The software product of claim 4 wherein the means for selecting desirable criteria is a programmed algorithm.

6. The software product of claim 4 wherein the means of selecting desirable criteria is based on user criteria.

7. A method for using a preferential choice system, comprising the steps of:
a. providing a first computer device;
b. providing a user interface on the first computer device, wherein a user may create a user account and profile;
c. providing the user profile being created by means of selecting at least one or more of a plurality of appropriate images associated with at least one or more of a plurality of provided word prompts;
d. providing a data repository, wherein one or more of a plurality of user profiles are stored;
e. providing a means for selecting desirable criteria within the one or more of a plurality of user profiles; and
f. providing a means for viewing the one or more of a plurality of user profiles which meet the desired selection criteria.

8. The method for using a preferential choice system of claim 7 wherein the step of providing a means for selecting desirable criteria further comprises the step of providing an algorithm for selecting desirable criteria.

9. The method for using a preferential choice system of claim 7 wherein the step of providing a means for selecting desirable criteria further comprises the step of providing user criteria for selecting desirable criteria.
